(19) United States
(12) Patent Application Publication
(10) Pub. No.: US 2007/0217779 A1
(43) Pub. Date: Sep. 20, 2007

(54) Recapture of electrical charge from a capacitor to a battery

(76) Inventors: William Robert Haas, Fort Collins, CO (US); Kirk Steven Tecu, Greeley, CO (US); John Mark Carleton, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/374,948

(22) Filed: Mar. 14, 2006

(51) Int. Cl. G03B 7/26

(52) U.S. Cl. 396/205

(57) ABSTRACT

An apparatus for recapturing electrical charge from a capacitor is provided. The apparatus includes a charge recovery controller configured to generate a signal indicating when the electrical charge from the capacitor is to be recovered. The apparatus also contains a charge recovery circuit configured to transfer the electrical charge from the capacitor to a battery upon receipt of the signal.

### BACKGROUND

After years of continual improvement and refinement, digital cameras now provide an attractive alternative to photographic film cameras, due primarily to their affordability, ease of use, advanced resolution, large image storage capability, and other factors. Nevertheless, due to increasing competition between digital camera manufacturers, the process of improving upon current digital camera offerings continues unabated. Any potential advantage provided by a digital camera over the competition for the benefit of the customer can result in augmented sales, and hence additional revenue, for the manufacturer.

One particular facet of digital cameras often targeted for improvement is battery life. Since batteries provided for powering digital cameras are often of the rechargeable variety, extending the time between recharging cycles is desirable for most customers. For example, recharging batteries is impractical in a number of circumstances, such as boating trips, mountain hikes, and the like, when accessibility to an external power source is limited.

Many efforts at extending battery life have focused on increasing the charge capacity of batteries, and on enhancing the power efficiency of the camera itself, especially when performing various functions, such as image capture, optical zoom, and others. While such efforts have yielded significant increases in battery life up to this point, further such improvements using these same or similar methods are likely to be less dramatic.

### BRIEF DESCRIPTION OF THE DRAWINGS

FIG. 1 is a simplified schematic diagram of a circuit according to an embodiment of the invention employable within a digital camera for recapturing electrical charge from a capacitor.

FIG. 2 is a schematic diagram of a charge recovery circuit employable within the circuit of FIG. 1 according to an embodiment of the invention.

FIG. 3 is a simplified timing diagram outlining the operation of the charge recovery circuit of FIG. 2 according to an embodiment of the invention.

FIG. 4 is a flow diagram of a method for recapturing charge from a capacitor according to another embodiment of the invention.

### DETAILED DESCRIPTION

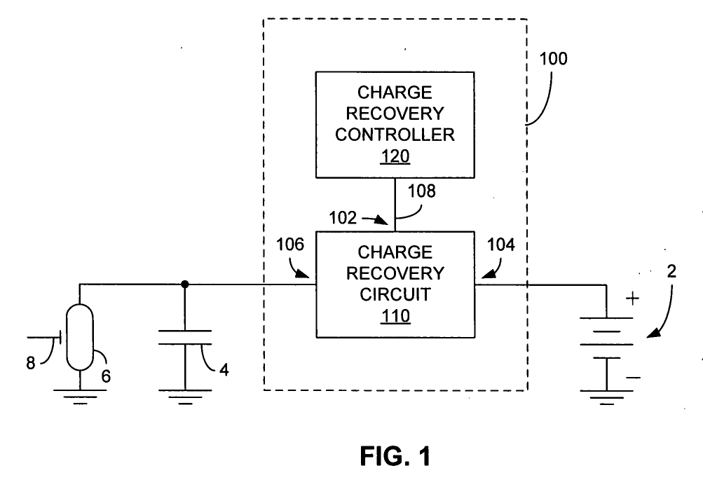

One particular way in which battery life can be further extended is by recapturing electrical charge stored in a capacitor back into the battery when the functionality of the capacitor is no longer immediately required. One embodiment of the invention, an apparatus 100 for performing this task, is depicted in the simplified block diagram of FIG. 1. Contained in the apparatus 100 are a charge recovery circuit 110 and a charge recovery controller 120, each of which is described in greater detail below.

In the specific embodiment of FIG. 1, a capacitor 4 storing the electrical charge to be recaptured is a strobe (or flash) capacitor employed within a camera, such as a digital camera, for supplying electrical energy to a flash tube 6. When energized, the flash tube 6 generates a flash for illuminating a subject to be captured as an image. Specifically, the electrical charge stored in the flash capacitor 6 is dumped quickly to the flash tube 6 upon excitation of a control electrode 8, thus initiating the flash. In other embodiments, the capacitor 4 may be any capacitor capable of storing a significant amount of charge that could be later recovered for other purposes.

Also shown in FIG. 1 is a battery 2 for receiving the electrical charge recovered from the capacitor 4. In one embodiment, the battery 2 is a rechargeable battery typically utilized in digital cameras, although other types of rechargeable batteries may be employed in other embodiments. In one example, the electrical charge stored in the capacitor 4 originates from the battery 2 by way of a capacitor charging circuit not shown in FIG. 1.

Referring to the apparatus 100, the charge recovery controller 120 is configured to generate a signal 108 indicating when electrical charge is to be recovered from the capacitor 4. In one embodiment, the signal 108 is generated when the device in which the apparatus 100 resides, such as a digital camera, is turned off. Typically, as part of a power-up procedure, a digital camera will cause the flash capacitor 4 to be energized by way of the battery 2. Once the camera is turned off, the capacitor 4 need not remain charged, as leakage current will tend to drain the charge from the capacitor 4 over an extended period of time, thus wasting the charge. Thus, transferring at least a portion of the charge from the capacitor 4 back to the battery 2 would be desirable once the camera is turned off.

In another embodiment, the signal 108 is generated when the camera is placed in a “no-flash” mode. Such a mode could occur, for example, when the camera is brought from a dark room to a more brightly-lit location, such as outdoors, thus reducing or eliminating the need for a flash. In another example, a no-flash mode could be employed for long exposure times, time-lapse imaging, and other imaging uses.

The charge recovery controller 120 may take any of a number of forms. In one implementation, the charge recovery controller 120 may be software instructions executable on a processor, such as a microprocessor, microcontroller, or similar algorithmic processing unit. In another example, the charge recovery controller 120 is electronic hardware, such as that found within an application-specific integrated circuit (ASIC) for generating the signal 108. A combination of software and hardware may be employed in yet another embodiment to provide the charge recovery controller 120.

The charge recovery circuit 110 of FIG. 1 is configured to transfer the electrical charge from the capacitor 4 to the battery 2 upon receipt of the signal 108 from the charge recovery controller 120. The charge passes from the capacitor 4 to the battery 2 through the charge recovery circuit 110.

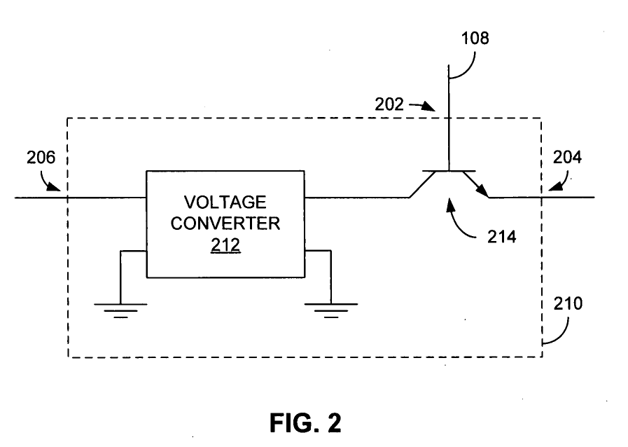

One embodiment of the charge recovery circuit 110 is the charge recovery circuit 210 shown in FIG. 2. The terminals 202, 204, 206 of the charge recovery circuit 210 correspond with the similarly-enumerated terminals 102, 104, 106, respectively, of the charge recovery circuit 110 of FIG. 1. The charge recovery 210 includes a voltage converter 212 configured to convert a first voltage across the capacitor 4 (presented in FIG. 1) at terminal 206 to a second voltage. In this example, the voltage converter 212 is a direct-current-to-direct current (DC-to-DC) converter which converts a high voltage of the capacitor 4 to a relatively lower voltage associated with the battery 2. For example, the high voltage may be approximately 300 volts (V), attainable by the capacitor 4 for use by the flash tube 6 to generate a flash. The lower voltage may be approximately 4 V, corresponding to a voltage of the battery 2 when fully-charged. In another example, the lower voltage may be less than that exhibited by a fully-charged battery 2, but at least of a magnitude to support satisfactory operation of the camera.

A switch 214 positioned between the voltage converter 212 with the battery 2 (shown in FIG. 1) is configured to electrically couple the voltage converter 212 with the battery 2 when the signal 108 is received, thus transferring the charge of the capacitor 4 through the voltage converter 212 to the battery 2, thus at least partially replenishing the charge in the battery 2. In the particular example of FIG. 2, the switch 214 is an n-p-n bipolar transistor with its collector coupled with the output of the voltage converter 212, its emitter coupled with the battery 2, and its base being driven by the signal 108. Other possible switches 212 include other bipolar transistors and field effect transistors (FETs).

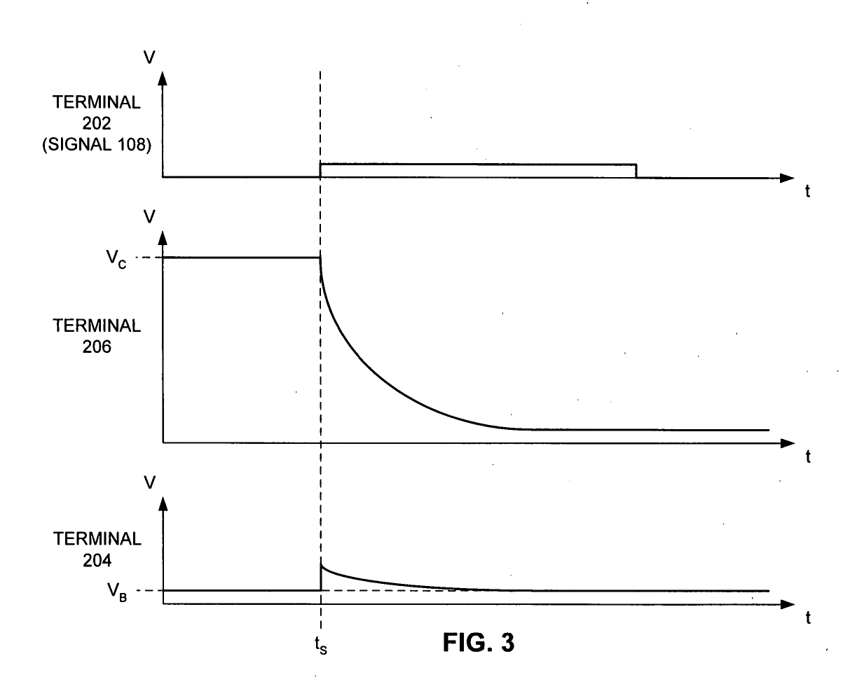

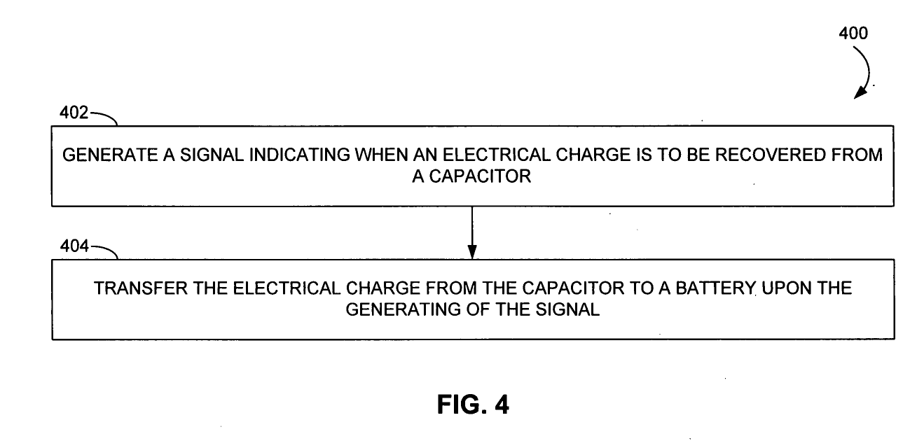

FIG. 3 presents a simplified timing diagram outlining the operation of the apparatus 100 of FIG. 1, when utilizing the charge recovery circuit 210 of FIG. 2. Shown in FIG. 4 is the voltage at each terminal 204, 206, 208 of the charge recovery circuit 210 during the time of a charge recovery operation. At a time t_{S}, the signal 208 is generated by the charge recovery controller 120, which in this case is a pulse of sufficient duration to allow the switch 214 to remain closed for at least the length of time required to transfer as much charge as possible that is stored in the capacitor 4 to the battery 2. Prior to the pulse, while the switch 214 is open, the capacitor 4 is charged to a relatively high voltage V_{C}. During that same time, the voltage across the battery 2 V_{B} is a normal operating voltage, typically much lower than the high capacitor voltage V_{C}.

When the pulse of the signal 208 begins at t_{S}, the switch 214 is closed, causing charge from the capacitor 4 to be transferred across the voltage converter 212 and the switch 214 to the battery 2, thereby causing the voltage across the battery 2 (at terminal 204) to initially rise above the normal operating voltage V_{B}, thus storing charge into the battery 2. As the charge is transferred from the capacitor 4 to the battery 2, the voltages at the associated terminals 206, 204 decrease until no more charge is yielded from the capacitor 4. At some point thereafter, the pulse of the signal 208 may be terminated, thus once again opening the switch 214.

Given the particular configuration of the charge recovery circuits 110, 210, at least some portion of the charge that would otherwise be wasted through current leakage of the capacitor 4 is transferred back into the battery 4 when the charge in the capacitor 4 is not required. In the specific example of a camera, the charge is not needed in the capacitor when the attached flash tube is not to be operated, such as when the camera is turned off or placed in a no-flash mode. Depending on the use of the camera, such as when the camera is turned off between each image capture over a long series of images, the total amount of charge recovered may be significant.

In another embodiment of the invention, a method 400 for recapturing electrical charge from a capacitor is illustrated in the flow diagram of FIG. 4. While the method 400 may be performed by the apparatus 100, other apparatuses not specifically described herein may also be employed to perform the method 400 in alternative embodiments. In the method 400, a signal indicating when the electrical charge is to be recovered from the capacitor is generated (operation 402). The electrical charge is transferred from the capacitor to a battery upon the generating of the signal (operation 404).

In one particular embodiment of the method 400, the transferring of the electrical charge is accomplished by way of converting a first voltage from the capacitor as a result of the electrical charge to a second voltage compatible with the battery, and by electrically coupling the voltage converter with the battery in response to generating the signal. In one specific implementation, the second voltage is higher than a voltage of the battery in a fully-charged state, as described above.

The generating of the signal may occur when a device incorporating the capacitor, such as a camera, is turned off. In another implementation, the signal is generated when the camera is placed in a no-flash mode.

While several embodiments of the invention have been discussed herein, other embodiments encompassed by the scope of the invention are possible. For example, while some embodiments of the invention are described above in conjunction with digital cameras, other types of cameras, such as ordinary photographic film cameras, and other types of portable devices deriving power from a rechargeable battery, may also benefit from application or adaptation of the various embodiments, as presented above. Further, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. An apparatus for recapturing electrical charge from a capacitor, comprising:
a charge recovery controller configured to generate a signal indicating when the electrical charge from the capacitor is to be recovered; and
a charge recovery circuit configured to transfer the electrical charge from the capacitor to a battery upon receipt of the signal.

2. The apparatus of claim 1, wherein the charge recovery circuit comprises:
a voltage converter configured to convert a first voltage across the capacitor to a second voltage compatible with the battery; and
a switch configured to electrically couple the voltage converter with the battery when the signal is received.

3. The apparatus of claim 2, wherein the second voltage is higher than a voltage of the battery in a fully-charged state.

4. The apparatus of claim 2, wherein the switch comprises a transistor.

5. The apparatus of claim 1, wherein the charge recovery controller comprises at least one of software instructions executable on a processor and electronic circuitry.

6. A camera, comprising:
the apparatus of claim 1;
the capacitor; and
a flash tube configured to receive the electrical charge from the capacitor to generate a flash.

7. The camera of claim 6, wherein the charge recovery controller is configured to generate the signal when the camera is turned off.

8. The camera of claim 6, wherein the charge recovery controller is configured to generate the signal when the camera is placed in a no-flash mode.

9. A method for recapturing electrical charge from a capacitor, comprising:
generating a signal indicating when the electrical charge is to be recovered; and
transferring the electrical charge from the capacitor to a battery upon the generating of the signal.

10. The method of claim 9, wherein transferring the electrical charge comprises:
converting a first voltage from the capacitor as a result of the electrical charge to a second voltage compatible with the battery; and
electrically coupling the voltage converter with the battery in response -to generating the signal.

11. The method of claim 10, wherein the second voltage is higher than a voltage of the battery in a fully-charged state.

12. The method of claim 9, wherein generating the signal occurs when a camera is turned off.

13. The method of claim 9, wherein generating the signal occurs when a camera is placed in a no-flash mode.

14. An apparatus for recapturing electrical charge from a capacitor, comprising:
means for generating a signal indicating when the electrical charge is to be recovered; and
means for transferring the electrical charge from the capacitor to a battery upon the generating of the signal.

15. The apparatus of claim 14, wherein the transferring means comprises:
means for converting a first voltage from the capacitor as a result of the electrical charge to a second voltage compatible with the battery; and
means for electrically coupling the voltage converter with the battery in response to generating the signal.

16. The apparatus of claim 15, wherein the second voltage is higher than a voltage of the battery in a fully-charged state.

17. The apparatus of claim 14, wherein generating the signal occurs when a camera is turned off.

18. The apparatus of claim 14, wherein generating the signal occurs when a camera is placed in a no-flash mode.
